(19) United States
(12) Patent Application Publication
(10) Pub. No.: US 2024/0228158 A1
(43) Pub. Date: Jul. 11, 2024

(54) CAPSULE FOR PREPARING A BEVERAGE BY A BEVERAGE PRODUCTION DEVICE

(71) Applicant: SOCIETE DES PRODUITS NESTLE S.A., Vevey (CH)

(72) Inventors: CHRISTOPHE SEBASTIEN PAUL HEYDEL, Chez-Le-Bart (CH); FREDERIC DOLEAC, Vaux et Chantegrue (FR); ALEXANDRE PERENTES, Sullens (CH)

(21) Appl. No.: 18/558,793

(22) PCT Filed: Apr. 4, 2022
(86) PCT No.: PCT/EP2022/058855

§ 371 Date: Nov. 3, 2023

(30) Foreign Application Priority Data
May 4, 2021 (EP) 21172013.1

(51) Int. Cl. B65D 85/804; A47J 31/22

(52) U.S. Cl. CPC B65D 85/8064; A47J 31/22

(57) ABSTRACT

The invention relates to a capsule (1, 1′) designed for insertion in a beverage production device (100) for preparing a beverage from a substance contained in the capsule (1, 1′) by introducing liquid into the capsule (1,1′) and, optionally, by passing the so introduced liquid through the substance using centrifugal forces. The capsule (1,1′) comprises: a body (2) defining an enclosure for containing an amount of beverage substance, the body (2) comprising a bottom end and an open end; a flange-like rim (22) extending outwardly from the body (2); an upper wall (3, 3′) attached to the flange-like rim (22) to cover an opening (21) of the body (2) at its open end; and an annular ring (4, 4′) that is separately provided and clampable between the flange-like rim (22) and the beverage production device (100) when the capsule (1, 1′) is inserted in the beverage production device (1, 1′) for preparing the beverage. The annular ring (4, 4′) is made at least partly of a biodegradable and/or compostable material.

### FIELD OF THE INVENTION

The present invention relates to a capsule designed for insertion in a beverage production device for preparing a beverage from a substance contained in the capsule by introducing liquid into the capsule and, optionally, by passing the so introduced liquid through the substance using centrifugal forces.

### TECHNICAL BACKGROUND

A beverage production device usually prepares a beverage such as coffee by brewing methods using pressure pumps. These brewing methods require the variation of several brewing parameters to achieve a good quality of the beverage. For example, a traditional espresso requires different brewing parameters than a lungo coffee. These parameters may include pressure, flow rate, compaction of the substance such as coffee powder, particle size of the substance, temperature, water flow distribution, etc. Due to the variety of the brewing parameters, it is difficult to achieve a high quality beverage.

As an alternative to that, a beverage production device may prepare the beverage from a substance contained in the capsule using centrifugal forces. In such a device, liquid passes through the substance contained in the capsule by using brewing centrifugal forces. For example, the device injects the liquid into the capsule and rotates the capsule by rotational driving means. Thereby, centrifugal forces are effected to act upon the injected liquid, which then passes through the substance. Under the centrifugal effect, the brewed liquid, prepared from the liquid passing through the substance, is then forced through opening means to leave the capsule.

Such brewing by using centrifugal forces has several advantages over the normal brewing method using pressure pumps. For example, the centrifugal effect more uniformly distributes the liquid in the capsule. Further, less or no preferential flow paths in the substance, such as a coffee bed, are created compared to the traditional brewing methods. Accordingly, brewing under the centrifugal effect leads to a higher quality. In particular, the centrifugal effect can lead to amounts of coffee solids in the cup which are higher than using traditional brewing methods. Further, the pressure of the liquid in the capsule can be easily controlled by the rotation of the capsule alone.

Thereby, different types of beverages (for example, coffee varieties with different tastes, intensities, and/or types, such as ristretto, espresso, lungo, long coffee) can be more conveniently produced without the need of mastering several brewing parameters as it is the case in the brewing methods using pressure pumps.

Preparing a beverage from a capsule using centrifugal forces, however, suffers from the drawback that the capsule requires a complex design for the effect that the liquid can properly pass through the substance for having a sufficient beverage quality. The quality includes, in particular, a sufficiently high aroma content of the coffee extract. In particular, the capsule has the complex design to enable the device to set different pressures for different beverages. For this reason, the capsule requires a body that includes, in a single part, different portions for different functionalities, respectively. For example, the body is provided as a monolithic part that on the one hand encloses the beverage substance and on the other hand interacts with the beverage production device to allow that the brewed liquid leaves the capsule only at or above a certain pressure. Due to the different functionalities of the body, the body comprises differently structured portions, such as a portion having gas barrier properties for enclosing the beverage substance and a portion for the interaction with the beverage production device, such as a portion in the form of a curled ring. The latter portion usually extends from a flange-like rim integrally provided with the body.

Such a design of the capsule makes it also difficult to properly recycle the capsule, since the capsule, in particular its body, include different materials in a single part for providing the before-mentioned different functionalities. Further, the production of such a capsule with different functionalities in a single part is difficult and thus also represents a disadvantage. Further, for the ease of manufacturing, the capsule body is often made entirely of one and the same material, even though certain portions of the capsule body do not require a special material such as a material providing a gas barrier (e.g., a material comprising EVOH and the like or aluminum or a laminate of plastic and aluminum). Such capsules are thus also disadvantageous due to the high amount of non-sustainable materials.

Besides that, the capsules are not sufficiently rigid to always withstand the rotational forces acting on the capsule for effecting the centrifugal forces for passing the liquid through the substance. This inferior rigidity of the capsule may lead to a beverage with an inferior quality. For example, a lacking rigidity allows the brewed liquid to leave the capsule too early and/or with a too little pressure, resulting in a beverage with an inferior quality.

Therefore, it is an objective of the present invention to provide a capsule that overcomes the above-mentioned disadvantages. In particular, it is an object of the present invention to propose a capsule that is more sustainable and at the same time provides a beverage with an improved quality.

These and other objects, which become apparent upon reading the following description, are solved by the subject matter of the independent claim. The dependent claims refer to preferred embodiments of the invention.

### SUMMARY OF THE INVENTION

According to the invention, a capsule designed for insertion in a beverage production device for preparing a beverage from a substance contained in the capsule by introducing liquid into the capsule and, optionally, by passing the so introduced liquid through the substance using centrifugal forces is provided. The capsule comprises: a body defining an enclosure for containing an amount of beverage substance, the body comprising: a bottom end and an open end; a flange-like rim extending outwardly from the body; an upper wall attached to the flange-like rim to cover an opening of the body at its upper end; and an annular ring that is separately provided and clampable between the flange-like rim and the beverage production device when the capsule is inserted in the beverage production device for preparing the beverage. The annular ring is made at least partly, and preferably completely, of a biodegradable and/or compostable material.

In the context of the present invention, a “biodegradable and/or compostable material” may be understood as any material that can be broken down into environmentally innocuous products by (the action of) living things such as microorganisms (bacteria, fungi, algae, etc.). The environmentally innocuous products, into which the biodegradable material is broken down, may be water, carbon dioxide, and biomass. Biodegradation may take place in an environment with the presence of oxygen (aerobic) and/or otherwise without the presence of oxygen (anaerobic). International standards (such as EU13432 or USASTMD6400) specify technical requirements and procedures for determining composability of a material.

The separately provided annular ring thus effects that the annular ring and other parts of the capsule, such as the body and/or the flange-like rim and/or the upper wall, are not formed in a single part or monolithic structure. In other words, the capsule may be obtained by the following steps: providing the body and the flange-like rim, e.g. as an integral unit; providing the annular ring as such; assembling the body (including the flange-like rim) and the annular ring together to form at least part of the capsule. The upper wall may be assembled to the flange-like rim before or after the assembly of the annular ring, or together with the assembly of the annular ring.

The capsule according to the invention provides the advantage of an improved sustainability. For example, the annular ring can be easily removed from the rest of the capsule due to not forming a single part or monolithic structure with the rest of the capsule. Thereby, there is no need to cut through the capsule for obtaining the annular ring as a separate part. Instead, the annular ring may be simply pulled off from the rest of the capsule to obtain the annular ring as such. The annular ring alone can then be put in a dedicated waste stream, namely a stream for biodegradable and/or compostable material. Similarly, the respective remainder of the capsule can be also put into one or more dedicated streams, such as a stream for biodegradable and/or compostable material and/or one or more recycling streams (e.g. a recycling stream for materials including aluminum or other non-biodegradable and/or non-compostable materials).

A further advantage of the capsule is its improved interaction with the beverage production device. For example, the annular ring clamped between the flange-like rim and the beverage production device reinforces both the body and the upper wall. This effects that the capsule has an improved rigidity, thereby maintaining the shape of the capsule, in particular of the body and the upper wall, when the capsule is inserted in and interacting with the beverage production device for the preparation of a beverage, e.g. by using centrifugal forces. In other words, forces acting on the capsule during the preparation of the beverage, such as the rotational forces of the device acting on the capsule to effect the centrifugal forces and thus the pressure of the liquid inside of the capsule, will less deform the capsule compared to a capsule that has the annular ring formed in a single unit with the flange-like rim or body. This in turn has a positive effect on the beverage to be prepared, since deviating brewing parameters due to an unwanted deformation of the capsule are prevented or at least reduced. In particular, the annular ring reinforces the upper wall, e.g. a membrane to be pierced, whereby the permeability of the upper wall for the liquid, being injected into and/or leaving the capsule, is improved.

The annular ring may be attached to the flange-like rim. Hence, the annular ring may at least partly connect directly to the flange-like rim. Thereby, the annular ring can be easily provided, since the flange-like rim provides a sufficient surface area for attaching the annular ring. The upper wall may be arranged to expose a part of the flange-like rim so that the flange-like rim can be attached to this exposed part of the flange-like rim. Thereby, the upper wall can be downsized, resulting in the use of less material.

Additionally or alternatively, the annular ring may be attached to the upper wall. In other words, the annular ring may at least partly connect indirectly, namely via the upper wall, to the flange-like rim. By attaching the annular ring to the upper wall, the upper wall is even further reinforced. Thereby, the upper wall can even better retain in its original shape, in particular during use in the beverage production device. In one embodiment, the annular ring is attached to the upper wall only. In another embodiment, the annular ring may be attached to both the flange-like rim and the upper wall. This has the advantage that the upper wall on the one hand has an improved rigidity and on the other hand requires less material. The upper wall may be sandwiched between the annular ring and the flange-like rim. This has the effect that the upper wall is reinforced in an easy manner.

The annular ring may be attached (to the flange-like rim and/or the upper wall) by sealing or welding, such as ultrasonic welding. Therefore, the annular ring is attached in a very cost-effective way. Further, the attachment by means of sealing or welding effects that the annular ring can be easily separated (e.g. pulled off) from the flange-like rim and/or upper wall. Additionally or alternatively, the annular ring may be attached by an adhesive bond, such as by a glue. This also provides the advantage of an easy separation of the flange-like rim.

The annular ring may be injected and/or back-molded. The annular ring may be attached by in-mould labelling and/or by back-molding. For example, the annular ring may be back-molded with the flange-like rim and/or the upper wall in order to be attached. Alternatively, the flange-like rim and/or the upper wall may be back-molded with the annular ring in order to attach the latter.

The upper wall may be attached to a planar side of the flange-like rim, wherein the annular ring is arranged on and/or attached to this side. Thereby, the annular ring is positioned to be easily clampable between the flange-like rim and the beverage production device. Further, the upper wall and the annular ring can be attached from a same side of the flange-like rim which results in a cost-effective production of the capsule.

The annular ring may protrude, with a height, from the flange-like rim and/or the upper wall in a direction away from the bottom end. The protruding of the annular ring with a defined height effects that the annular ring can advantageously interact with the device. For example, the height may effect that the annular ring is compressed by a specific amount, which in turn results in a specific restoring force acting between the capsule and the device. This restoring force may be used to allow that the centrifugal forces effect a specific pressure inside of the capsule. The height may be selected dependent on the beverage to be prepared from the capsule. Preferably, the height is at least 1 mm (such as at least 2 or 3 mm) and/or at most 4 mm (such as at most 1, 2 or 3 mm). The height may be in the range from 1 to 3 mm.

The annular ring may have a thickness. The thickness may be measured perpendicular to the annular ring's height and/or may be the difference between the outer radius and the inner radius of the annular ring; the inner radius defines the inner perimeter of the annular ring, and the outer radius defines the outer perimeter of the annular ring. The thickness may be at least 1 mm (such as at least 2 or 3 mm) and/or at most 4 mm (such as at most 1, 2 or 3 mm). Preferably, the thickness is in the range from 1 to 3 mm. With a specific thickness of the annular ring, a specific rigidity of the annular ring can be set. This may be advantageous for the interaction with and the use in the beverage production device.

In other words, the annular ring may extend, relative to an axis surrounded by the annular ring, axially with the height and radially with the thickness. The axis may correspond to the axial direction mentioned below.

The annular ring may have an inner diameter that is greater than or equal to the diameter of the upper wall. In other words, the through opening of the ring may be defined by the inner diameter, wherein, in a top view, the upper wall is fully arranged inside of the through opening. That is, in a top view, the upper wall may not be covered by the annular ring. The inner diameter of the annular ring may be defined by an inner perimeter of the annular ring. The diameter of the upper wall may define an outer edge of the upper wall. The inner diameter of the annular ring may be in a range from 50 to 60 mm.

The annular ring may have an outer diameter that is smaller than or equal to the diameter of the upper wall. In other words, the annular ring may cover, in a top view, a part of the upper wall. Hence, the annular ring can be produced with less material without having an adverse effect on the upper wall's rigidity.

The annular ring may be flush with an outer edge of the flange-like rim. That is, the outer diameter of the annular ring may be equal to the diameter defining the outer edge of the flange-like rim. Hence, the flange-like rim does not need to extend beyond the annular ring in a direction away from the body. Thereby, the flange-like rim can be produced with less material, while still providing efficient rigidity in order to clamp the annular ring between the flange-like rim and the device.

In general, the annular ring may be circumferentially closed. In other words, the annular ring may not be formed as an open ring. When the circumferentially closed annular ring is clamped between the flange-like rim and the device there is thus no void or clearance in the ring through which the brewed liquid could leave the space delimited by the annular ring.

The annular ring may have a Young's modulus of at least 1000 MPa (preferably of at least 1200 or 4000 MPa) and/or of at most 15000 MPa (preferably of at most 5000 or 10000 MPa). Preferably, the annular ring has a Young's modulus in the range from 4000 to 15000 MPa for paper and a Young's modulus in the range from 1200 to 5000 MPa for plastic. In particular, the Young's modulus of the annular ring may define the amount of the restoring force of the annular ring when the annular ring is clamped between the flange-like rim and the device. Hence, the defined Young's modulus facilitates a defined interaction with the beverage production device, such as an interaction for setting a brewing pressure. In particular, the Young's modulus of the annular ring may be selected dependent on the beverage to be produced.

The material of the annular ring may comprise paper fibers, plant fibers, bamboo, paper pulp, bioplastic, or a mixture thereof. In general, the material of the annular ring may comprise one or more plant-based materials, such as wood, bamboo, bamboo fiber, cellulose, cellulose pulp, wood pulp, sugar cane pulp, paper, and/or cardboard.

The bioplastic may include materials such as polyhydroxybutyrate (PHB) and co-polymers, polybutylene succinate (PBS), poly(butylene succinate-co-butylene adipate) (PBS-A/PBSa), polylactide (PLA), polybutylene adipate terephthalate (PBAT), Cellulose Acetate, starch, and mixtures thereof.

The material of the annular ring may be different from the material of the body. For example, the material of the body may be different from the material of the annular ring in that the material of the body provides properties, such as a gas barrier, which the material of the annular ring does not need to provide. This may be the case because the annular ring does not need to provide one or more functions of the body's material, such as gas tightness. Similarly, the material of the annular ring may be different from the material of the body in that material of the annular ring provides a specific function, such as resiliency, which the material of the body does not need to provide. For example, the material of the annular ring may provide more flexibility than the material of the body.

The annular ring may be configured to provide a flow restriction valve for the (e.g., centrifuged) beverage flow leaving the capsule when the annular ring is clamped between the flange-like rim and the device. In other words, the annular ring may be clamped between a pressing surface of the device and the flange-like rim and configured, together with this pressing surface, to selectively block the flow path of the (e.g., centrifuged) liquid to delay the release of the liquid from the capsule. When a sufficient pressure of the liquid is reached at the annular ring, the annular ring may compress due to its resiliency and open a restricted flow gap between the pressing surface and the annular ring. Thereby, the annular ring, clamped between the flange-like rim and the (pressing surface of the) device, can set a defined pressure that is effected by the (e.g., centrifuged) liquid in the capsule. Thus, the introduced liquid in the capsule can pass through the substance under the effect of the centrifugal forces during a specific interaction time and with a specific pressure. As a result, a thorough wetting of the substance is made possible and the extraction characteristics can be significantly improved.

The flange-like rim may be integral with the body. Consequently, the flange-like rim and the body can be efficiently produced, namely in a single unit. For example, the flange-like rim is obtained by forming a part of the body, such as by bending the body.

The bottom end and the open end of the body may be spaced apart in an axial direction, wherein the flange and/or the upper wall extend(s) transversely, such as perpendicularly, to the axial direction. The axial direction may extend transversely or perpendicularly to the upper wall. Additionally or alternatively, the flange-like rim extends in a plane that comprises the opening of the body.

The body, preferably including the flange-like rim, may be at least partly, and preferably completely, made of a biodegradable and/or compostable material. The biodegradable and/or compostable material may be like the one described above for the annular ring. That is, the material of the body may comprise paper fibers, plant fibers, bamboo, paper pulp, bioplastic, or a mixture thereof. The material of the body may comprise one or more plant-based materials, such as wood, bamboo, bamboo fiber, cellulose, cellulose pulp, wood pulp, sugar cane pulp, paper, and/or cardboard. The bioplastic may include materials such as polyhydroxybutyrate (PHB) and co-polymers, polybutylene succinate (PBS), poly(butylene succinate-co-butylene adipate) (PBS-A/PBSa), polylactide (PLA), polybutylene adipate terephthalate (PBAT), Cellulose Acetate, starch, and mixtures thereof. Additionally or alternatively, the material of the body may have a multilayer or laminate structure. For example, a first layer may comprise a biodegradable and/or compostable material, wherein a second layer comprises gas barrier properties. The material may comprise moulded fibers.

Additionally or alternatively, the body may be at least partly formed of a food grade plastic, e.g., polypropylene, with a gas barrier layer such as EVOH and the like or aluminium or a laminate of plastic and aluminium, such as aluminium-PP (polypropylene) laminate, wherein preferably PP forms the inner layer of the laminate and aluminium forms the outer layer of the laminate. Additional lacquers or colour layers can be provided. The body is preferably rigid or semi-rigid. Preferably, the body is more rigid than the annular ring.

The upper wall may be made of a biodegradable and/or compostable material, such as a material like the one described above for the annular ring. The upper wall may be formed of paper and plastic, paper and aluminium or a combination of paper, aluminium and plastic. Plastic may include biodegradable plastics such as crystallized PLA or equivalent. The upper wall may be made of a thinner material such as a plastic film also including a barrier layer or aluminium or a combination of plastic and aluminium. The upper wall is usually of a thickness between 10 and 250 microns, for example. The upper wall is designed to be perforated for creating the liquid inlet.

Instead of the upper wall, the capsule may as well comprise a rigid, semi-rigid or flexible engagement lid member which preferably has the form of a disc comprising a central portion having an inlet port for enabling the introduction of a liquid injection member and a peripheral portion having circumferentially arranged outlet openings.

Preferably, the whole capsule is made of the biodegradable and/or compostable material.

### DESCRIPTION OF PREFERRED EMBODIMENTS

In the following, the invention is described exemplarily with reference to the enclosed figures, in which

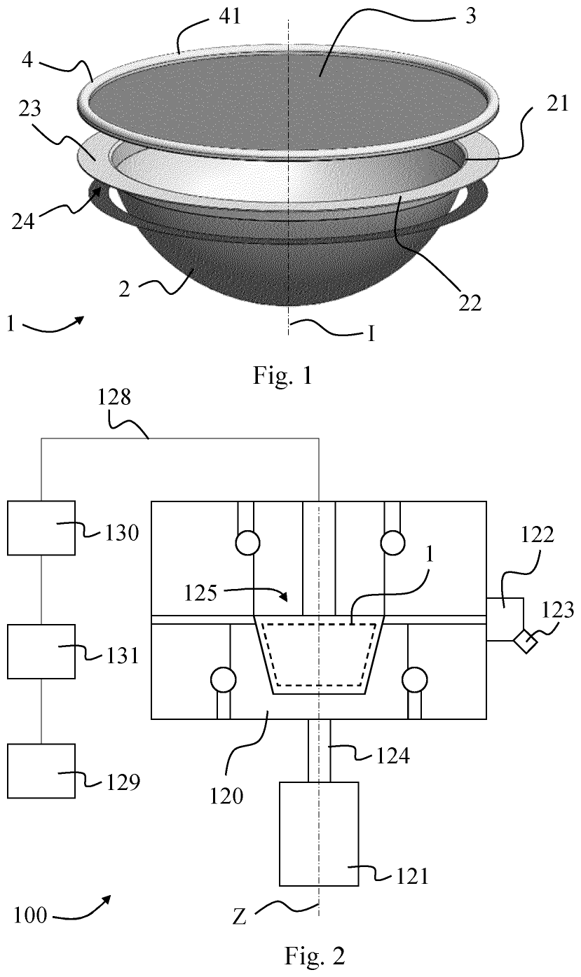

FIG. 1 is a schematic perspective view of a capsule according to a first preferred embodiment of the invention;

FIG. 2 is a schematic cross-sectional view of a beverage production device, into which the capsule shown in FIG. 1 is inserted to produce a beverage from the capsule using centrifugal forces;

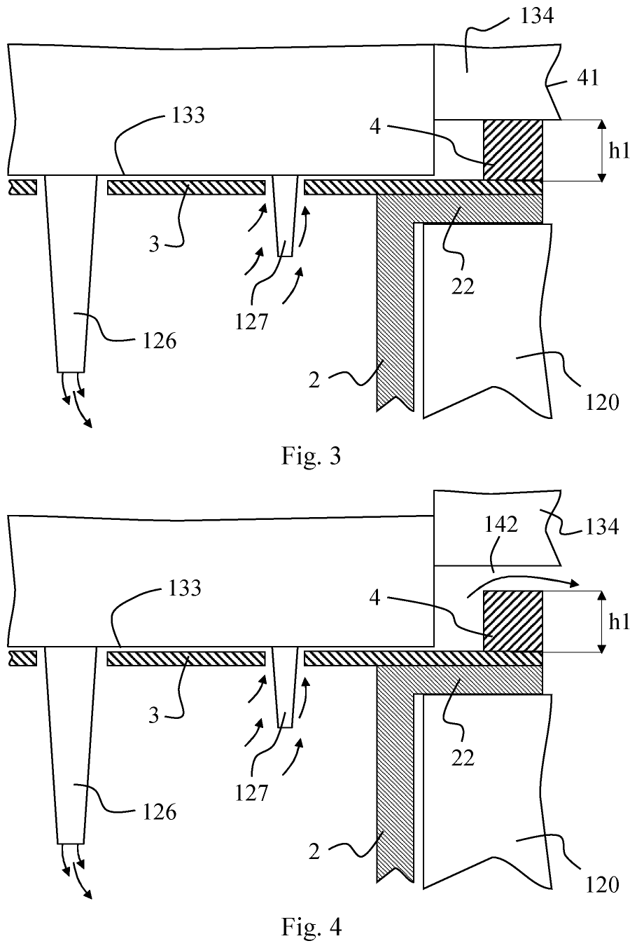

FIG. 3 is a schematic detailed cross-sectional view of the beverage production device with the therein inserted capsule of FIG. 2 in a first state;

FIG. 4 is the detailed schematic cross-sectional view of FIG. 3 in a second state;

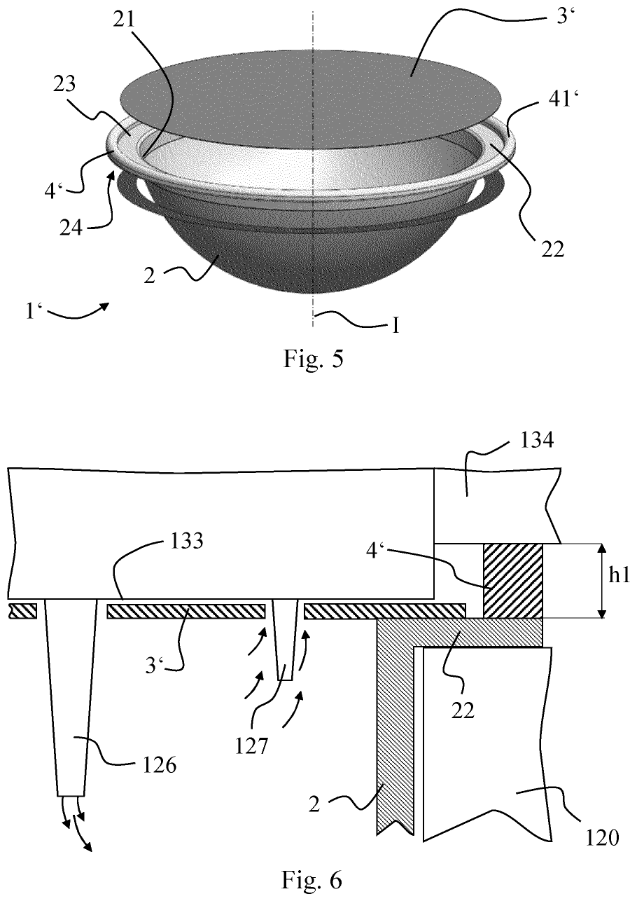

FIG. 5 is a schematic perspective view of a capsule according to a second preferred embodiment of the invention;

FIG. 6 is a detailed schematic cross-sectional view of the beverage production device shown in FIG. 2 with the capsule of FIG. 5 inserted therein in a first state; and

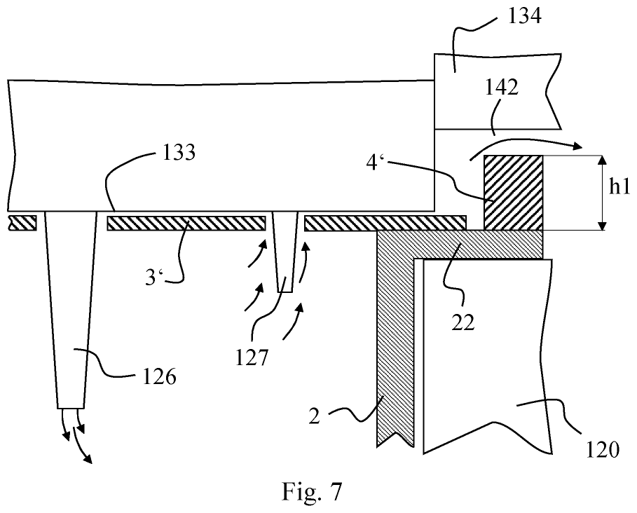

FIG. 7 is the detailed schematic cross-sectional view of FIG. 6 in a second state.

FIG. 1 shows a capsule 1 according to a first preferred embodiment. The capsule 1 comprises a body 2 that defines an enclosure for containing an amount of beverage substance. Preferably, the body 2 contains the beverage substance. The substance may include roast and ground coffee, soluble coffee, creamers (dairy or non-dairy), tea (e.g. grey, green, white, and/or herbal), cocoa, chicory, infant formula and combinations thereof. Additives may also be added such as sweeteners (sugar, aspartame, stevia, etc.), flavorings (cinnamon, vanilla, almond, herbs, etc.), processing aids, emulsifiers, foam boosters, fruit or plant extracts, micronutrients and combinations thereof.

The body 2 is not limited to a specific shape. As illustrated, the body 2 may have a convex portion for enclosing the beverage substance. However, the body 2 may also have a truncated or a cylindrical portion or a combination of portions of different shapes such as truncated, cylindrical, spherical, etc., for enclosing the beverage substance.

The body 2 has a bottom end and an open end, which are spaced apart in an axial direction I. The body 2 comprises an opening 21 at its open end. By way of the opening 21 the beverage substance may be filled into the body 2. The opening 21 is not limited to a specific form. As shown in FIG. 1, the opening 21 may have a circular form.

Further, the capsule 1 comprises a flange-like rim 22, which extends outwardly from the body 2 and transversely to the axial direction I. As illustrated, the flange-like rim 22 extends preferably perpendicularly to the axial direction I and in a plane comprising the opening 21. In other embodiments, the flange-like rim 22 may extend obliquely to the axial direction I. In this case, part of the flange-like rim 22 may extend in a plane that is oblique to the axial direction I. The flange-like rim 22 extends around the opening 21. Preferably, an inner edge (i.e., an edge facing the axial direction I) of the flange-like rim 22 delimits the opening 21.

The flange-like rim 22 is illustrated as being integral with the body 2. As such, the body 2 and the flange-like rim 22 may be produced or formed in a single part. In other embodiments, the body 2 and the flange-like rim 22 may be provided in two parts, respectively, which are attached together by attachment means, such as by an adhesive bond (glue, etc.).

The body 2 may be made of a material suitable for enclosing the beverage substance, in particular such that a specific (minimum) shelf life of the beverage substance is ensured. Preferably, the material of the body 2 is chosen to provide gas barrier properties. The material of the body 2 may be at least in part a biodegradable and/or compostable material. The biodegradable and/or compostable material may comprise paper fibers, plant fibers, bamboo, paper pulb, and/or bioplastic. The material of the body 2 may have a multilayer structure, such as a multilayer structure with one layer having gas barrier properties and one or more further layers providing the rigidity of the body 2. The one or more further layers may be made of the biodegradable and/or compostable material. The layer having gas barrier properties may be a coating applied onto the one or more further layers. This layer may also be made of the biodegradable and/or compostable material.

The material of the flange-like rim 22 may be made of a material that is identical to the material of the body 2. In other words, the body 2 and the flange-like rim 22 may be made from the same material. In other embodiments, the body 2 and the flange-like rim 22 may be made from different materials, respectively. For example, the body 2 comprises a material with gas barrier properties, whereas the flange-like rim 22 does not comprise a material with gas barrier properties.

The body 2 may comprise one or more structures (i.e., reinforcement structures), which increase the rigidity of the body 2. For example, the one or more structures may be arranged on a side facing into the body 2 or to an outside of the body 2. The one or more structures may comprise one or more indentations (grooves, notches, etc.) and/or one or more protrusions. The one or more structures may extend between the bottom end and the open end. In a side view of the capsule 1, the one or more structures may extend parallel or transversely (such as perpendicularly) to the axial direction I. The one or more structures may be distributed, such as evenly distributed, over the inner surface and/or outer surface of the body 2.

The capsule 1 further comprises an upper wall 3 attached to the flange-like rim 22 to cover the opening 21. The upper wall 3 may be attached to the flange-like rim 22 by sealing or welding, such as ultrasonic welding. In other embodiments, the upper wall 3 may be attached to the flange-like rim 22 by attachment means such as an adhesive bond (glue, etc.) Preferably, the attachment of the upper wall 3 to the flange-like rim 22 is such that the capsule 1 is closed or sealed in a gastight manner to ensure a defined shelf life of the beverage substance. As illustrated, the upper wall 3 may be attached to a planar side 23 of the flange-like rim 22. In other embodiments, the upper wall 3 may be attached to an edge (e.g., inner edge or outer edge) of the flange-like rim 22. The flange-like rim 22 preferably comprises an upper side that faces away from the bottom end of the body 2 and that comprises the planar side 23. This upper side is preferably the planar side 23. The flange-like rim 22 may comprise a lower side 24 that faces away from the open end of the body 2. The lower side 24 may face away from the upper side 23, and/or the sides 23, 24 may be on opposite sides of the flange-like rim 22.

The upper wall 3 may be in the form of a disc. Preferably, the upper wall 3 is a perforable membrane. The upper wall 3 may be designed to be perforated for creating a liquid inlet and/or liquid outlet. The upper wall 3 may be made of a perforable material, such as an aluminium foil. The upper wall 3 is arranged to enclose with the body 2 an enclosure for the beverage substance. In other words, the body 2 and the upper wall 3 delimit an ingredient compartment. The material of the upper wall 3 may comprise gas barrier properties so that the upper wall 3 and the body 2 enclose a gastight chamber that contains the beverage substance. The upper wall 3 may extend transversely to the axial direction I. This means that the axial direction I extends through the upper wall 3. As illustrated, the upper wall 3 may extend perpendicularly to the axial direction I. In other embodiments, the upper wall 3 may also extend obliquely to the axial direction I.

The capsule 1 further comprises an annular ring 4 that is separately provided. This means that the annular ring 4 does not form a single part or monolithic structure with the respective other parts of the capsule 1. Before assembling the capsule 1, the annular ring 4 is thus provided as such. In the assembled state of the capsule 1, the annular ring 4 is then attached to a part of the capsule. In the embodiment shown in FIG. 1, the annular ring 4 is attached to the upper wall 3. Thereby, the annular ring 4 is at least in part indirectly connected to the flange-like rim 22, namely by way of the upper wall 3. Further, the upper wall 3 is sandwiched between the annular ring 4 and the flange-like rim 22. The annular ring 4 may be attached to the upper wall 3 by sealing or welding, such as by ultrasonic welding. In other embodiments, the annular ring 4 may be attached to the upper wall 3 by attachment means such as an adhesive bond (glue, etc.). The upper wall 3 may comprise an attachment section to which the annular ring 4 is attached to. The attachment section may be substantially planar and/or may correspond to the form of the annular ring 4.

In the embodiment illustrated in FIG. 1, the annular ring 4 protrudes, with a height h1, from the upper wall 3 in a direction away from the bottom end. Preferably, this protruding direction is parallel to the axial direction I and/or perpendicular to the upper wall 3, i.e. to a plane in which the upper wall 3 extends. The height h1 is preferably comprised in a range from 1 to 4 mm, more preferably from 1 to 3 mm. The thickness of the annular ring 4 is preferably comprised in a range from 1 to 4 mm, more preferably from 1 to 3 mm. The thickness of the annular ring 4 may be measured along a direction perpendicular to the axial direction I and/or height h1.

In the embodiment illustrated in FIG. 1, the annular ring 4 has an outer diameter that is equal to the diameter that defines the perimeter or an outer edge of the upper wall 3. Hence, the inner diameter of the annular ring 4 is smaller than the diameter that delimits the upper wall 3. The outer diameter is defined by the outer perimeter of the annular form of the ring 4. The inner diameter is defined by the inner perimeter of the annular form of the ring 4. In the capsule 1, the outer perimeter of the annular ring 4 is thus flush with the perimeter that delimits the upper wall 3. In other embodiments, the outer diameter may be smaller than the diameter of the upper wall 3. In this case, the outer perimeter of the annular ring 4 may not be flush with the perimeter that delimits the upper wall 3. Thereby, a plane section of the upper wall 3, which section is delimited by the perimeter (i.e. outer edge) of the upper wall 3, may remain free. In other words, in a top view of the upper wall 3 (e.g. viewed along the direction I), a plane section may extend between the perimeter delimiting the upper wall 3 and the outer perimeter of the annular ring 4. The plane section may be annularly formed.

The capsule 1 illustrated in FIG. 1 comprises the annular ring 4 in such a way that the annular ring 4 is flush with an outer edge of the flange-like rim 21. Thus, the outer diameter of the annular ring 4 may be equal to a diameter that defines the outer edge of the flange-like rim 22. When viewed along the direction I, the annular ring 4 preferably does not expose a part of the flange-like rim 22 that comprises the outer edge. This part may be the planar side 23 of the flange-like rim 22.

The annular ring 4 is made of a material that is at least in part, and preferably completely, biodegradable and/or compostable. Suitable materials are, for example, paper fibres, plant fibres, bamboo, paper pulp, bioplastic, or a mixture thereof. The material of the annular ring 4 may be different from the material of the body 2. For example, the material of the annular ring 4 may have a greater biodegradability and/or compostability than the material of the body 2. This may be because the material of the body 2 provides functions (gas tightness, rigidity, etc.), which the material of the annular ring 4 does not need to provide.

The annular ring 4 may provide a defined elasticity, such as for an interaction with a beverage production device. The elasticity of the annular ring 4 may be defined by the ring's geometry and/or material. For example, the annular ring 4 may be made of a material that has a Young's modulus comprised in a range from 1000 to 15000 MPa. If the annular ring 4 is made, partly or completely, of paper, the Young's modulus may be comprised in a range from 4000 to 15000 MPa. If the annular ring 4 is made, partly or completely, of plastic (i.e., an at least partly biodegradable plastic, such as bioplastic), the Young's modulus may be comprised in a range from 1200 to 5000 MPa. Additionally or alternatively, the geometry of the annular ring 4 may be selected to provide a defined elasticity. For example, the annular ring 4 may have a specific cross-section, such as a hollow or solid cross-section. The annular ring 4 may have at least in part a circular and/or rectangular cross-section. The annular ring 4 is, however, not limited to a specific shape (geometry) and/or specific Young's modulus.

The capsule 1 is suitable to be inserted in a beverage production device (beverage preparation device) for preparing a beverage by introducing a liquid into the capsule 1 and, optionally, by passing the so introduced liquid through the substance using centrifugal forces. FIG. 2 exemplarily shows such a beverage production device 100, into which the capsule 1 is inserted for the preparation of a beverage. FIGS. 3 and 4 show a detail of the beverage production device 100 in interaction with the capsule 1 in different states, respectively. However, the capsule 1 may be also used in a beverage production device that prepares a beverage (e.g., coffee) from the substance using other brewing methods, such as a brewing method that uses a pressure pump.

As shown in FIG. 2, the beverage production device 100 comprises a rotating capsule holder 120, a driving device 121, and a collector 122 onto which the centrifuged liquid impacts and drains through a beverage outlet 123. The driving device 121 may comprise a rotary motor which is linked to the capsule holder 120 at the bottom side (as illustrated) or top side (not illustrated) through an axle 124 axially connected to the capsule holder 120. Thereby, the driving device 121 can rotate the capsule 1 around a rotation axis Z. Preferably, when the capsule 1 is inserted in the beverage production device 100, such as in the capsule holder 120, the capsule's axial direction I is parallel to and/or coincides with the rotation axis Z. The capsule holder 120 may have a circumferential surface that forms a referencing diameter substantially equal to a diameter of the capsule 1, such as of the body 2, so as to ensure a tight fit of the capsule 1 in the capsule holder 120 without possible radial play. The capsule holder 120 is preferably hollow or deep enough at its centre to be able to accommodate capsules of different size and/or type. Accordingly, a unique capsule holder is sufficient to receive capsules of different size and/or type. It should be noted that the capsule holder 120 can take various shapes and may also be formed of a simple annular hollow ring. The one or more (reinforcement) structures may be arranged to engage with the capsule holder 120. This effects that the rotational movement of the capsule holder 120 is efficiently transferred to the capsule 1. The flange-like rim 22 may be directly or indirectly supported on the capsule holder 120.

Furthermore, the beverage production device 100 comprises liquid injection device 125 having an injection member 126 being arranged to perforate the upper wall 3 of the capsule 1, preferably in a central portion thereof. The injection device 126 may be connected to a liquid circuit 128 comprising a liquid supply 129 such as a water tank, a pump 130 and a liquid heating apparatus 131 for providing a predefined volume of heated pressurized liquid to the capsule 1 during the beverage extraction process. Liquid is usually water (heated, ambient, or cooled). The liquid is fed in the capsule 1 by injection through the injection member 126 having the form of a hollow needle or tube. The injection member 126 can be formed of a sharp free end to ensure perforation of the upper wall 3, if necessary. The beverage production device 100 may also comprise one or more outlet perforators 127. The one or more outlet perforators 127 may be provided at the periphery of the engagement lid 133 which engages the upper wall 3 of the capsule 1 during closure of the device 100. Accordingly, outlets are produced in the upper wall 3 thereby enabling an extracted (centrifuged) beverage to leave the capsule 1 during the rotational movement thereof.

The device 100 may further comprise a control unit which controls the different elements of the device 100, in particular, the pump 130, heater 131 and rotational speed of the driving means 121. In particular, the control unit is programmed to adjust operational parameters during extraction including (but not limited to): pump flow rate, pump pressure, water temperature, rotational speed, rotational speed cycles (e.g., speeds during prewetting, extraction, drying phases, etc.). Several programs can be designed specifically to the different types of capsules, for example delivering specific beverages, e.g., ristretto, espresso, lungo, Americano, etc., and/or beverages having specific strength, aroma profiles, foam/crema volume, etc. The capsule 1 can comprise an identification code, such as a barcode, radio-frequency tag, etc., for enabling the identification in the device 100 and for setting of the operational parameters automatically. In this case, the device comprises a suitable code reading device associated to the control unit. The control unit and code can be configured to ensure a control of key brewing parameters such as any one or any combinations of the following parameters: liquid volume (small, medium, long, extra-long cups, etc.), rotational speed of the driving means, liquid pump speed or speed cycle (e.g., slow speed for prewetting, high speeds for extraction and drying), liquid heating temperature, etc. The identification code may be arranged on the lower side 24 of the flange-like rim 22. For example, a support element may support or carry the identification code (such as in the form of a barcode), wherein the support element is arranged on and/or attached to the lower side 24.

For preparing the beverage from the capsule 1, the capsule 1 is inserted in the beverage production device 100. In this inserted state, as exemplarily shown in FIG. 3, the annular ring 4 is clamped between the flange-like rim 22 and the beverage production device 100. For example, the device 100 may engage a portion 41 of the annular ring 4. The portion 41 may be convex. In other embodiments, the portion 41 may be flat. Liquid is then injected into the capsule 1 via the injection member 126. Then, the driving device 121 is controlled to drive the capsule 1 in rotation to perform the centrifugal brewing operation. Under the effect of the so effected centrifugal forces, the substance tends to compact itself radially whereas the liquid is forced to be guided along the inner surface of the side wall of the body 2 and to flow through the substance. This results in the substance being both compacted and wetted by the liquid. Thereby, a liquid extract (such as a liquid coffee extract) is obtained. The liquid extract is then forced to flow upwards and then through the perforated outlet openings created in the upper wall 3 by the perforating members 124. The liquid can be filtered by the interstice created between the perforators 127 and the upper wall 3 to ensure that non-soluble solid (e.g., coffee) particles are maintained in the capsule 1. Filtration may also be carried out by a separate filter inserted in the capsule 1 and/or device 100.

During this preparation of the beverage, the annular ring 4 is clamped between the flange-like rim 22 and the beverage production device 100. This effects that a clamping force is transferred to the capsule 1, whereby the capsule 1 becomes more rigid. Thus, during the centrifugal beverage preparation the capsule 1, in particular the body 2 and the upper wall 3, remains more in its original shape. Hence, beverage preparation is improved. The reinforced upper wall 3 has the further advantage that piercing of the upper wall 3 is improved. Thus, the elements 126, 127 can pierce the upper wall 3 without greatly deforming the upper wall 3 and/or body 2.

Further, the annular ring 4 may interact with the device 100 to set a brewing parameter in the centrifugal brewing operation. In particular, the annular ring 4 may interact with the device 100 to set a pressure for brewing the beverage from the substance contained in the capsule 1. Therefore, if the liquid in the capsule 1 has a pressure below the set pressure, the liquid remains in the capsule 1 for the interaction with the substance. If the pressure of the liquid in the capsule 1 however rises under the effect of the centrifugal forces to a pressure at or above the set pressure, the liquid extract flows out of the capsule 1 to be dispensed as the beverage. Hence, the interaction of the annular ring 4 with the device 100 can ensure that the optimal brewing pressure is used for preparing the beverage. The pressure used during brewing the beverage may be set based on the height of the annular ring 4. Thus, different pressures may be set by different heights of the annular ring 4, respectively.

FIGS. 3 and 4 illustrate an example for such an interaction of the annular ring 4 with the device 100 to set a brewing pressure. In the state shown in FIG. 3, the annular ring 4 clamped between the flange-like rim 22 and the device 100 effects that a valve member 134 is compressed. The compression of the valve member 134 exerts a force onto the annular ring 4 according to Hooke's law. In the state shown in FIG. 3, the rotational speed of the capsule 1 effects centrifugal forces, which are not yet sufficient to create a pressure for properly preparing the beverage. For this reason, the pressure inside the capsule 1 cannot effect a force that overcomes the force exerted by the compressed valve member 134 onto the annular ring 4. Thus, the valve 134 remains closed. In the state shown in FIG. 4, the centrifugal forces however create a pressure that is suitable for properly preparing the beverage. Thus, the pressure inside the capsule 1 effects a force that overcomes the force exerted by the compressed valve member 134 onto the annular ring 4. Consequently, an opening or gap 142 is created between the valve member 134 and the annular ring 4, e.g. its portion 41, through which the liquid extract can pass for being dispensed out of the capsule 1. The dispensed liquid extract, e.g. a coffee beverage, may then flow towards the collector 122 and/or the beverage outlet 123.

Additionally or alternatively, the annular ring 4 clamped between the flange-like rim 22 and the device 100 may effect that the annular ring 4 is compressed. The compression of the annular ring 4 exerts a force onto the device 100 (such as the valve member 134) according to Hooke's law. In other words, the (restoring) force will depend on the ring's defined elasticity (see above). Thus, if the centrifugal forces create a pressure that is suitable for properly preparing the beverage, the pressure inside the capsule 1 effects a force that overcomes the force exerted by the compressed annular ring 4. Consequently, an opening or gap is created between the device 100 (such as the valve member 134) and the annular ring 4, e.g. its portion 41, through which the liquid extract can pass for being dispensed out of the capsule 1. The dispensed liquid extract, e.g. a coffee beverage, may then flow towards the collector 122 and/or the beverage outlet 123.

In FIG. 5, a second preferred embodiment of a capsule 1′ is shown. In FIG. 5, the same reference signs are used for components equivalent to those in FIG. 1. The capsule 1′ comprises annular ring 4′ that corresponds to the annular ring 4 of the first embodiment with the difference that the annular ring 4′ is attached to the flange-like rim 22, preferably to the planar side 23 as illustrated in FIG. 5. Thereby, the annular ring 4′ is directly connected to the flange-like rim 22. The annular ring 4′ may be attached to the flange-like rim 22 by sealing or welding, such as by ultrasonic welding. In other embodiments, the annular ring 4′ may be attached to the flange-like rim 22 by attachment means such as an adhesive bond (glue, etc.). The flange-like rim 22 may comprise an attachment section to which the annular ring 4′ is attached to. This attachment section may be substantially planar and/or may correspond to the form of the annular ring 4′. In the embodiment illustrated in FIG. 5, the annular ring 4′ protrudes, with the height h1, not from the upper wall 3 but from the flange-like rim 22.

In the embodiment illustrated in FIG. 5, the annular ring 4′ has an inner diameter that is greater than the diameter defining the perimeter (i.e., an outer edge) of the upper wall 3′. In other embodiments, the inner diameter of the annular ring 4′ may be equal to the diameter of the upper wall 3′. The upper wall 3′ corresponds to the upper wall 3 of the first embodiment with the difference that the upper wall 3 has a smaller size (i.e., a smaller surface area) than the upper wall 3. Thus, the capsule 1′ can be produced with a reduced amount of material.

FIGS. 6 and 7 show a detail of the beverage production device 100 of FIG. 2, wherein the capsule 1′ is inserted into the device 100 instead of the capsule 1. FIGS. 6 and 7 show the beverage production device 100 in interaction with the capsule 1′ in different states, respectively. The interaction of the capsule 1′ with the device 100 is substantially the same as the interaction of the capsule 1 with the device 100 as described above with reference to FIGS. 2-4. The interaction of the capsule 1′ with the device 100 differs from the interaction of the capsule 1 with the device 100 in that, the annular ring 4′ is clamped between the flange-like rim 22 and the beverage production device 100 in such a way that a clamping force is transferred directly from the annular ring 4′ to the flange-like rim 22. That is, in contrast to the first embodiment, the clamping force is not indirectly (via the upper wall 3) transferred to the flange-like rim.

The clamped annular ring 4′ also effects that the capsule 1′ becomes more rigid. Thus, during the centrifugal beverage preparation, the capsule 1′, in particular the body 2 and the upper wall 3′, remains more in its original shape. Hence, beverage preparation is improved. The reinforced upper wall 3′ has the further advantage that not only a reduced amount of material is required but that also piercing of the upper wall 3′ is improved.

In sum, the capsule 1, 1′ provides several advantages. For example, since the annular ring 4, 4′ is separately provided, i.e. does not form a monolithic structure with other parts of the capsule 1, 1′, the annular ring 4, 4′ can be easily removed as such after the use of the capsule 1, 1′. That is, after the use of the capsule 1, 1′, the capsule 1, 1′ can be easily disassembled into different discrete parts, namely at least into the body 2 with the flange-like rim 22, the upper wall 3, 3′, and the annular ring 4, 4′. Hence, the different discrete parts can be put in different waste streams, whereby the capsule 1, 1′ has an improved sustainability. Due to the annular ring 4, 4′ being made of a material that is at least partly, and preferably completely, made of a biodegradable and/or compostable material, the sustainability of the capsule 1, 1′ is even further improved. Moreover, the annular ring 4, 4′ has the advantage of giving the capsule 1 an improved rigidity during use in the beverage production device 100. Thereby, the brewing parameters can remain as desired during the centrifugal brewing operation, resulting in an improved liquid extract and thus beverage. Further, the annular ring 4, 4′ can provide an advantageous interaction with the beverage production device 100. As explained above, the annular ring 4, 4′ may interact to set a brewing pressure, whereby the control to brew the beverage from the capsule 1, 1′ is simplified.

It should be clear to a skilled person that the embodiments shown in the figures are only preferred embodiments, but that, however, also other designs of a capsule can be used.

1. A capsule designed for insertion in a beverage production device for preparing a beverage from a substance contained in the capsule by introducing liquid into the capsule, the capsule comprising:
a body defining an enclosure for containing an amount of beverage substance, the body comprising a bottom end and an open end;
a flange-like rim extending outwardly from the body;
an upper wall attached to the flange-like rim to cover an opening of the body at its open end;
an annular ring that is separately provided and clampable between the flange-like rim and the beverage production device when the capsule is inserted in the beverage production device for preparing the beverage; and
wherein the annular ring is made at least partly of a biodegradable and/or compostable material.

2. The capsule according to claim 1, wherein the capsule is designed for preparing a beverage from a substance contained in the capsule by passing the so introduced liquid through the substance using centrifugal forces.

3. The capsule according to claim 1, wherein the annular ring is attached to the flange-like rim and/or the upper wall, and/or wherein the upper wall is sandwiched between the annular ring and the flange-like rim.

4. The capsule according to claim 3, wherein the annular ring is attached by sealing or welding.

5. The capsule according to claim 3, wherein the annular ring is attached by an adhesive bond, and the annular ring is attached by in-mould labelling and/or by back-molding.

6. The capsule according to claim 1, wherein the upper wall is attached to a planar side of the flange-like rim, and wherein the annular ring is arranged on and/or attached to this side.

7. The capsule according to claim 1, wherein the annular ring protrudes, with a height, from the flange-like rim and/or the upper wall in a direction away from the bottom end, wherein the height is preferably at least 1 mm.

8. The capsule according to claim 1, wherein the annular ring has an outer diameter that is smaller than or equal to the diameter of the upper wall.

9. The capsule according to claim 1, wherein the annular ring has an inner diameter that is greater than or equal to the diameter of the upper wall.

10. The capsule according to claim 1, wherein the annular ring is flush with an outer edge of the flange-like rim.

11. The capsule according to claim 1, wherein the annular ring has a Young's modulus of at least 1000 MPa.

12. The capsule according to claim 1, wherein the material of the annular ring is selected from the group consisting of paper fibres, plant fibres, bamboo, paper pulp, bioplastic, and a mixture thereof.

13. The capsule according to claim 1, wherein the material of the annular ring is different from the material of the body.

14. The capsule according to claim 1, wherein the flange-like rim is integral with the body, and wherein the bottom end and the open end are spaced apart in an axial direction, and wherein the flange-like rim and the upper wall extend(s) transversely, to the axial direction.

15. The capsule according to claim 1, wherein the body is at least partly made of a biodegradable and/or compostable material, and/or wherein the material of the body has a multilayer structure.
